(19) United States
(12) Patent Application Publication
(10) Pub. No.: US 2017/0289917 A1
(43) Pub. Date: Oct. 5, 2017

(54) DYNAMIC TIME DIVISION DUPLEX INTERFERENCE MITIGATION IN A WIRELESS NETWORK

(71) Applicant: NOKIA SOLUTIONS AND NETWORKS OY, Espoo (FI)

(72) Inventors: Eugene VISOTSKY, Buffalo Grove, IL (US); Frederick VOOK, Schaumburg, IL (US); Mark CUDAK, Rolling Meadows, IL (US)

(21) Appl. No.: 15/088,866

(22) Filed: Apr. 1, 2016

(51) Int. Cl. H04W 52/14; H04W 72/12; H04W 16/28

(52) U.S. Cl. CPC H04W 52/143; H04W 16/28; H04W 72/1252

(57) ABSTRACT

An example implementation may include transmitting, by a first base station to a second base station, a beam-specific power down request value for one or more beams. Another example implementation may include receiving, by a second base station from a first base station, a beam-specific power down request value for one or more beams, and decreasing, by the second base station, transmit power for one or more transmit beams based on the beam-specific power down request value for the one or more beams.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments.

A global bandwidth shortage facing wireless carriers has motivated the consideration of the underutilized millimeter wave (mmWave) frequency spectrum for future broadband cellular communication networks. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, above 6 GHz. For fifth generation wireless systems (5G), an access architecture for deployment of cellular radio equipment employing mmWave radio spectrum has been proposed.

### SUMMARY

According to an example implementation, a method may include transmitting, by a first base station to a second base station, a beam-specific power down request value for one or more beams.

According to another example implementation, an apparatus may include at least one processor and at least one memory including computer instructions, when executed by the at least one processor, cause the apparatus to: transmit, by a first base station to a second base station, a beam-specific power down request value for one or more beams.

According to another example implementation, a computer program product may include a computer-readable storage medium and storing executable code that, when executed by at least one data processing apparatus, is configured to cause the at least one data processing apparatus to perform a method including: transmitting, by a first base station to a second base station, a beam-specific power down request value for one or more beams.

According to another example implementation, an apparatus may include means for transmitting, by a first base station to a second base station, a beam-specific power down request value for one or more beams, and means for transmitting, by the first base station to the second base station, an uplink-downlink configuration for the first base station.

According to an example implementation, a method may include receiving, by a second base station from a first base station, a beam-specific power down request value for one or more beams; and decreasing, by the second base station, transmit power for one or more transmit beams based on the beam-specific power down request value for the one or more beams.

According to another example implementation, an apparatus may include at least one processor and at least one memory including computer instructions, when executed by the at least one processor, cause the apparatus to: receive, by a second base station from a first base station, a beam-specific power down request value for one or more beams; and decrease, by the second base station, transmit power for one or more transmit beams based on the beam-specific power down request value for the one or more beams.

According to another example implementation, a computer program product may include a computer-readable storage medium and storing executable code that, when executed by at least one data processing apparatus, is configured to cause the at least one data processing apparatus to perform a method including: receiving, by a second base station from a first base station, a beam-specific power down request value for one or more beams; and decreasing, by the second base station, transmit power for one or more transmit beams based on the beam-specific power down request value for the one or more beams.

According to another example implementation, an apparatus may include means for receiving, by a second base station from a first base station, a beam-specific power down request value for one or more beams; and means for decreasing, by the second base station, transmit power for one or more transmit beams based on the beam-specific power down request value for the one or more beams.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating a wireless network in which downlink beam-specific interference from base station 1 is received by base station 2 according to an example implementation.

FIG. 3 is a diagram illustrative downlink-to-uplink (DL-to-UL) interference according to an example implementation.

FIG. 4 is a diagram illustrating operation of a network in which interference mitigation is performed according to an example implementation.

FIG. 5 is a diagram illustrating SINR gain of a system that uses DL interference mitigation, as compared to a system that did not use DL interference mitigation, according to an illustrative example.

FIG. 6 is a flow chart illustrating operation of a base station according to an example implementation.

FIG. 7 is a flow chart illustrating operation of a base station according to an example implementation.

FIG. 8 is a block diagram of a wireless station (e.g., base station or mobile station) according to an example implementation.

### DETAILED DESCRIPTION

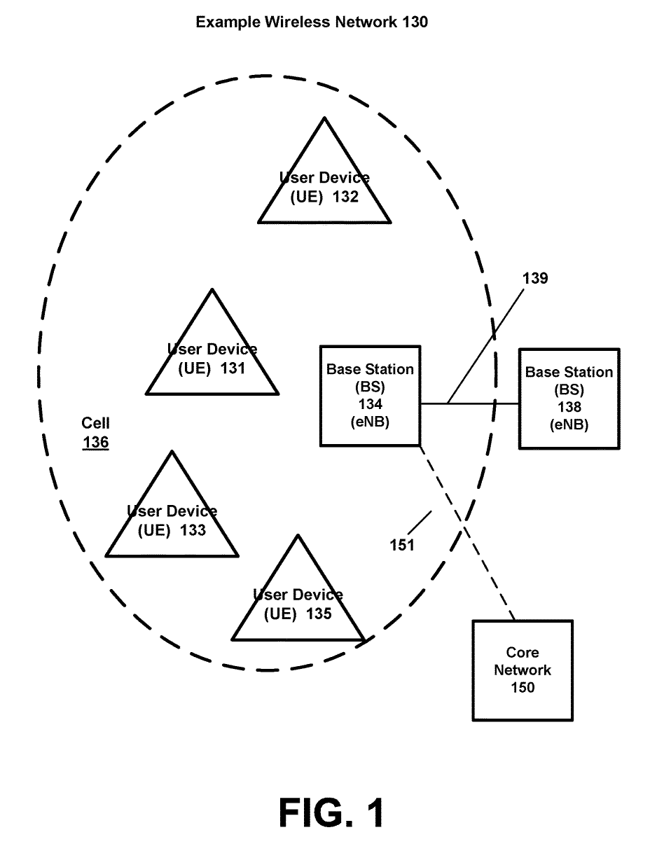

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an enhanced Node B (eNB). At least part of the functionalities of a base station or (e)Node B (eNB) may be also be carried out by any node, server or host which may be operably coupled to a transceiver, such as a remote radio head. BS 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used. BS 134 may be connected to one or more other BSs, such as BS 138, via a BS-to-BS interface 139.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, and/or mmWave band networks, or any other wireless network. LTE, 5G and mmWave band networks are provided only as illustrative examples, and the various example implementations may be applied to any wireless technology/wireless network.

According to an example implementation, (BSs and/or MSs) may use a multi-antenna array to perform beamforming, where a transmit beam (by a transmitter) or a receive beam (by a receiver) may be generated as one of a plurality of narrow beams. According to an illustrative example implementation, a grid-of-beams system may be used for control and/or data planes. In an illustrative example implementation of 5G communication systems, including those envisioned for the higher frequency bands (e.g., cmWave or mmWave), both control and/or data transmissions may involve the use of a switched grid-of-beams to overcome poor path loss conditions. The switched grid-of-beams concept may involve the use of a large number of high-gain, narrow beamwidth quasi-non-overlapping/orthogonal beams. In such a system, broadcast control information can be repeated in time over each of the beams in the grid to provide broadcast coverage over the cell in situations where an omni or sector-based beam pattern would not have sufficient gain to reach the cell edge with sufficient reliability/data rate. For data transmissions, typically the best beam would be selected to transmit (e.g., unicast) data information to a MS.

According to an example implementation, prior to signal transmission by one or more of the antennas in the array of antennas, for example, a set of beam weights V₁, V₂, . . . or V_{Q} (e.g., one beam weight applied to each antenna) may mixed with the signal at respective antennas of an antenna array to apply a gain and phase to the signal for transmission. For example, a gain and phase, V₁, V₂, . . . or V_{Q}, may be applied to the signal output to scale the signal transmitted by each antenna, where the phase(s) may be used to steer or point a beam transmitted by the overall antenna array, e.g., for directional beam steering. Thus, the beam weights V₁, V₂, . . . or V_{Q} (e.g., each beam weight including a gain and/or phase) may be a set of transmit beamforming beam weights when applied at or during transmission of a signal to transmit the signal on a specific beam, and may be a set of receive beamforming beam weights when applied to receive a signal on a specific beam.

In addition, time division duplex (TDD) may be used in a wireless system/network where a single carrier may be used for both uplink (UL) and downlink (DL) communications between a BS and one or more MSs. A frame may be partitioned into multiple subframes or slots. In an illustrative example, a frame may include 10 subframes, e.g., where some subframe(s) within a frame may be allocated/used for UL communications, and other subframe(s) may be allocated/used for DL communications. According to an example implementation, dynamic TDD may be used to allocate varying amounts of resources for UL and DL communications, e.g., depending on traffic demands. For example, a larger number of UL subframes may be used within a frame when the demand for UL traffic increases, and a larger number of DL subframes may be allocated/used when a demand for DL traffic increases. For example, multiple UL-DL configurations may be provided that allow each cell/sector or BS to allocate different subframes for UL and DL communications. The UL-DL configurations used by neighboring or adjacent cells/BS (or in some cases, used by all cells/BSs within a network) may be subframe-aligned (or slot-aligned), such that each subframe is aligned (coincides in time or synchronized) with subframes in other cells within a network. Cells/BSs may dynamically change the UL-DL configuration to change the allocation of subframe resources for UL versus DL communication, e.g., based on traffic demands. While dynamic TDD may, at least in some cases, increase data throughput or may increase signal to interference plus noise ratio (SINR), dynamic TDD may also create a situation where cells/BSs are more likely to create DL-to-UL interference where DL communications from one cell/BS may interfere with UL communications to an adjacent (or nearby) cell/BS.

In TDD, DL-to-UL interference (e.g., a DL signal from a first BS interferes with an UL signal received by a second BS) may be especially problematic in some cases where beamforming or narrow beams are used for transmission. Such DL-to-UL interference by an interfering BS may prevent the receiving BS (that receives the DL interference from nearby BS) from receiving and/or decoding the desired UL signals/data from a MS and/or may decrease SINR of such UL signals/data.

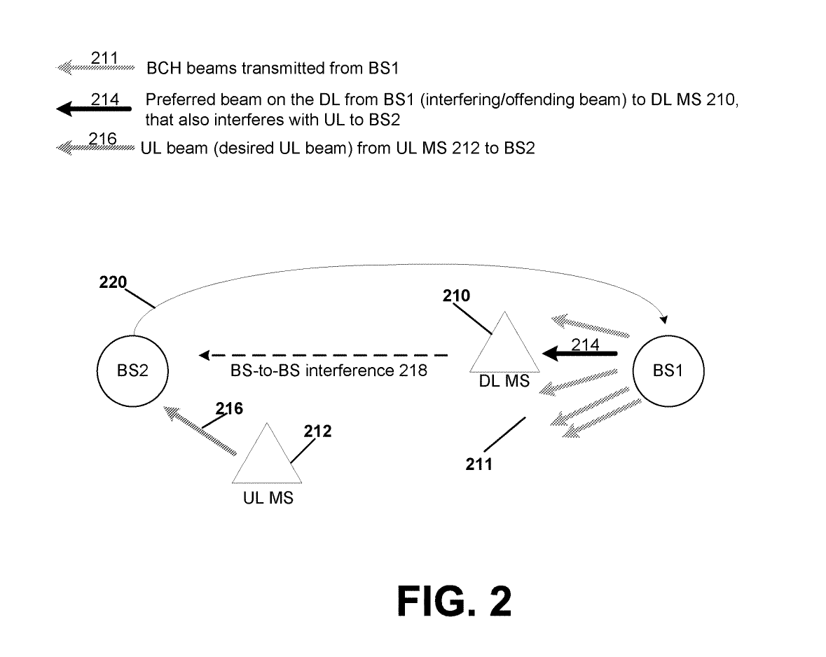

FIG. 2 is a diagram illustrating a wireless network in which downlink beam-specific interference from base station 1 (BS1) is received by base station 2 (BS2) according to an example implementation. In this illustrative example shown in FIG. 2, BS1 may transmit signals via a plurality of transmit beams 211, including a beam 214 that is a preferred beam for transmitting data/signals from BS1 to MS 210. At the same time (e.g., during a same subframe) of the DL transmission from BS1 via beam 214, a MS 212 is transmitting an UL signal/transmission 216 to BS2. However, in this example, the narrow transmit beam 214 (from BS1 to MS 210) also lines up (or aligns) with BS2. Thus, the DL transmission from BS1 via beam 214 is also received by BS2 in the form of BS-to-BS interference 218. Thus, DL-to-UL interference (from BS1 to BS2) 218 may occur, in this illustrative example, when BS1 is transmitting DL signals via beam 214 at the same time when BS2 is receiving UL signals 216 from MS 212 (for example). Thus, as can be seen, inter-cell/BS interference may particularly problematic when an interfering BS/cell is transmitting DL when an adjacent or nearby BS/cell is receiving an UL transmission from a MS, e.g., due to narrower beams and/or greater transmit power for signals transmitted DL from a BS as compared to lower power UL signals. This type of BS-to-BS (or cell-to-cell) interference may be referred to herein as DL-to-UL interference.

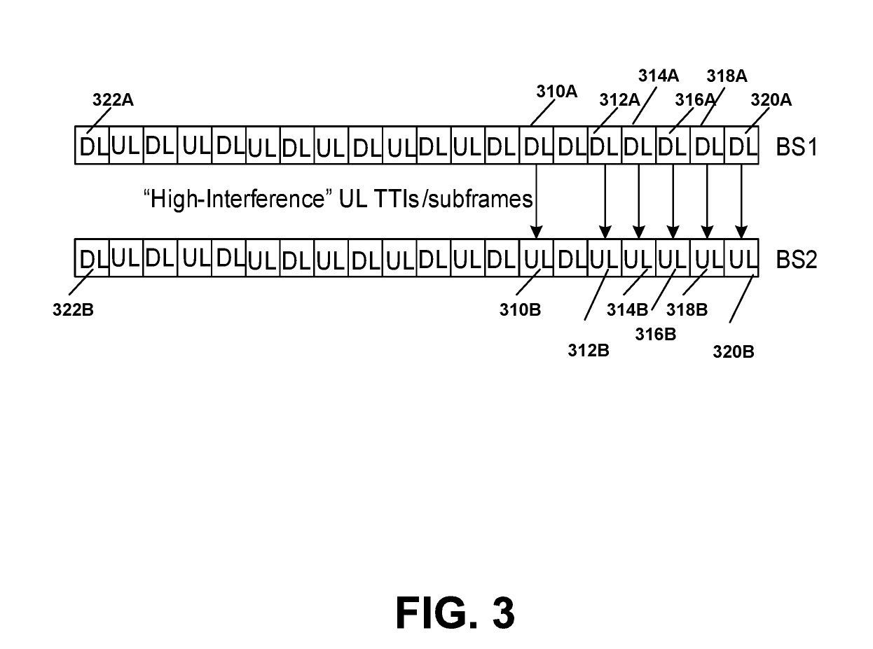

FIG. 3 is a diagram illustrative downlink-to-uplink (DL-to-UL) interference according to an example implementation. A plurality of subframes are shown for BS1 and for BS2, with reference to FIG. 2. As noted, in this illustrative example, the DL-to-UL interference occurs when BS 1 is transmitting DL signals and BS2 is receiving UL signals. Thus, as shown in FIG. 3, DL-to-UL interference may occur based on the DL transmissions from BS1 in subframes 310A, 312A, 314A, 316A, 318A and 320A, which may interfere with UL transmissions to BS2 in subframes 310B, 312B, 314B, 316B, 318B and 320B, respectively.

Therefore, referring to FIGS. 2 and 3, in order to mitigate the DL-to-UL interference, according to an example implementation, BS2 (the interfered BS/cell) may provide feedback to BS1 via backhaul connection or interface (BS-to-BS interface). The feedback may include, for example, a beam-specific power down request value(s), provided by BS2 to BS1, for one or more offending/interfering beams. In this manner, according to an example implementation, BS-to-BS feedback may be provided in order to provide interference mitigation on the UL in the operation of a dynamic TDD system.

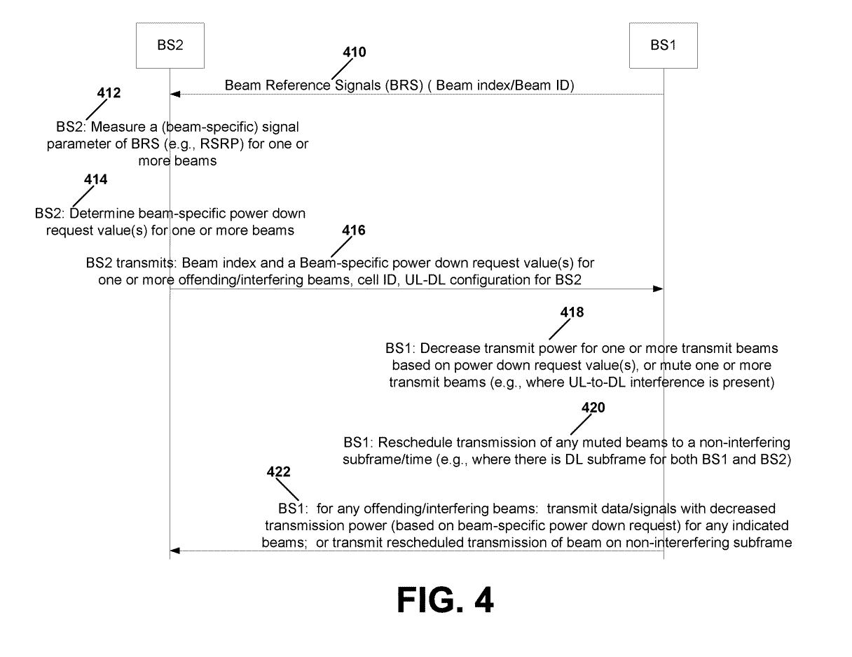

FIG. 4 is a diagram illustrating operation of a network in which interference mitigation is performed according to an example implementation. BS1 (an interfering BS, as shown in FIGS. 2-3), and BS2 (a BS that is interfered with, as shown in FIGS. 2-3) are shown in FIG. 4. At 410, BS1 may transmit a beam reference signal (BRS) for each of a plurality of beams, including a BRS for each of the beams 211 (including for an example offending/interfering beam 214). Each BRS may include a beam index (or beam ID/identifier) that identifies the beam, a cell ID, and other signals (e.g., a set of pilot signals or reference signals).

At 412, BS2 may measure a (beam-specific) signal parameter (e.g., measure received power, reference signal received power (RSRP), SINR, signal error rate, or other signal parameter measurement) for a beam reference signal (BRS) (or other signal) received from BS1 for each of a plurality of beams. For example, as BS1 cycles through the transmission of its BRS for each of a plurality of beams, BS2 may receive each of these BRS signals for the plurality of beams, and may measure RSRP (or other signal parameter) for each BRS. For example, BRS (beam reference signals) for beams (e.g., beam 214, FIG. 2) from BS1 that are aligned with BS2 will have a greater RSRP (as measured by BS2) than beams that are not aligned with the measuring/receiving BS (BS2). The beams having a greater RSRP, as measured by BS2, are more likely to cause DL-to-UL interference at BS2. Thus, according to an example implementation, power down request values for these highest value/highest power beams may be provided by BS2 to BS1 in order to mitigate (or decrease) DL-to-UL interference that may be caused by these beams.

At 414, BS2 determines a beam-specific power down request value(s) for one or more beams based on the signal parameter (e.g., RSRP or other signal parameter) for the one or more beams. For example, BS2 may compare the signal parameter of each beam to one or more thresholds in order to determine a power down request value for one or more of the beams. A threshold(s) may be received by BS2 from the core network or other BS, or BS2 may determine a threshold(s).

According to an example implementation, if a RSRP for a beam (or RSRP of a BRS for a beam) is less than or equal to a threshold, then no power down request value is provided for that beam. If the RSRP of a beam (or RSRP of a BRS for the beam) is greater than the threshold, then a power down request value is provided for such beam, requesting that the transmit power for such beam be decreased, for example.

According to another example implementation, if a RSRP of a beam/BRS is less than a first threshold, then a power down request value is not used or provided for such beam; if a RSRP of a beam/BRS is greater than a first threshold, then a first power down request value is applied; if the RSRP of a beam/BRS is less than the first threshold but greater than a second threshold (less than the first threshold), then a second power down request value (e.g., that is less than the first power down request value) may be applied or be used for that beam; and, if the RSRP of the beam/BRS is less than the second threshold and greater than a third threshold (less than the second threshold), then a third power down request value is applied for the beam. Also, if a RSRP of a beam/BRS is less than the third threshold, then a power down request value is not used or provided for such beam (e.g., a power down request value is not necessary in this example). Each power down request value may indicate a power backoff value indicating an amount of power decrease (e.g., −5 dB, −10 dB, . . . ) that should be applied when transmitting the indicated beam (at least for the offending/interfering subframes where the DL-to-UL interference may occur).

An example threshold may be an average observed interference level (as observed by BS2, without the BRS signals). This is merely an example threshold, and other threshold(s) may be used. For example, the greater the relative value of the RSRP of the BRS as compared to the average observed interference level (or other threshold), then a greater power down request value is applied or used for decreasing the transmission power of such beam.

Table 1 below illustrates, by way of illustrative example, some example power down request values (e.g., expressed in dB) for various RSRP values. While the RSRP values in Table 1 are expressed as a percentage of average observed interference level, the RSRP could also be listed simply in dB or magnitude of the RSRP, or value (in dB) of the RSRP in excess of (or over) the threshold. For example, for a RSRP greater than 6% of interference level and less than 11.9% of interference level a power down request value of −5 dB is used or applied for that beam, e.g., requesting a decrease of 5 dB of the transmit power for such beam. If the RSRP of a beam exceeds a specific threshold (e.g., exceeds 24% of average observed interference level in this example), then the power down request value for such beam may be a request to mute (or turn off/not transmit) of such offending/interfering beam, for example, at least for any offending/interfering subframe(s) (where the DL-to-UL interference may occur). In this manner, BS2 may measure the power/RSRP (or other signal parameter) of the interfering beam(s) from BS1, and then may determine a power down request value that requests the BS1 to decrease the transmit power of such offending/interfering beam(s) so that such beams do not interfere with UL transmissions received by BS2.

TABLE 1

| RSRP of Beam as a % of Avg. | |
|---|---|
| Observed Interference Level: | Power Down Request Value |
| 6%-11.9% | −5 dB |
| 12%-17.9% | −10 dB |
| 18%-23.9% | −15 dB |
| 24% or more | Mute beam |

In addition, according to an example implementation, the power down request value may be applied by BS1 only for subframes in which DL-to-UL interference may occur. In other words, according to an example implementation, a power down request value is applicable only for DL subframes of BS1 that align with UL subframes of BS2, such as subframes 310A, 312A, 314A, 316A, 318A and 320A of BS1, for example, which can interfere with subframes 310B, 312B, 314B, 316B, 318B and 320B, respectively, of BS2.

Also, in an example implementation, the BS2 may, in some example implementations, may determine if a beam that exceeds the threshold will be used by a MS to transmit UL to the BS2 (in an UL subframe for the BS2). If a beam that exceeds a threshold and will be used (or has been scheduled for use) for an UL subframe of the BS2, then the BS2 would determine and transmit a power down request value for such beam. If on the other hand, according to an example implementation, if such beam is not scheduled for use in an UL subframe of BS2 (for a MS to transmit to BS2), then the BS2 does not determine and/or transmit a power down request value for such beam (since there is no UL signal/subframe of BS2 to be interfered with). In another example implementation, BS2 may simply determine and report to BS1 a power down request value for one or more beams (e.g., having a RSRP that exceeds a threshold), regardless of whether such beam has been scheduled for use in an UL subframe of BS2. In an example implementation, BS2 may provide any power down request values and its UL-DL configuration to BS1, and BS1 applies the power down request values only for DL subframes of BS1 that align with UL subframes of BS2.

At 416, BS2 may transmit to BS1 (the interfering BS/cell) a beam-specific power down request value for one or more offending/interfering beam(s), e.g., to allow (or request) BS1 to decrease the transmit power and/or mute the offending/interfering beam(s), in order to mitigate or reduce DL-to-UL interference between nearby BSs/cells (e.g., between BS1 and BS2). This feedback from BS2 to BS1 may be provided via backhaul connection or interface (BS-to-BS interface). In this manner, BS-to-BS feedback may be provided in order to provide interference mitigation on the UL in the operation of a dynamic TDD system.

As shown at 416 of FIG. 4, according to an example implementation, BS2 may transmit a power down request value and a beam index (or beam ID to identify the beam) for one or more offending/interfering beams, a cell ID to identify the cell or BS (e.g., BS2) that is sending the power down request, and the UL-DL configuration (or TDD configuration) for BS2. Some example UL-DL configurations are shown in FIG. 3. Each cell or BS may be using a different UL-DL configuration, for example. In an example implementation, BS2 may provide any power down request values and its UL-DL configuration to BS1, and BS1 applies the power down request values only for DL subframes of BS1 that align with UL subframes of BS2. Thus, BS1 may use the received UL-DL configuration of BS2 to determine which of the DL subframes of BS1 align (or coincide) with UL subframes of BS2.

At 418, BS1 may decrease transmit power for one or more transmit beams (or in some cases, mute or not transmit a beam) based on power down request value(s) of one or more beams. According to an example implementation, the power down request values are applied or used to decrease transmit power (or mute) one or more beams only for subframes where DL-to-UL interference may occur, e.g., based on the UL-DL configurations of both BS1 and BS2. Therefore, in this illustrative example, BS1 applies the power down request value(s) only for DL subframes of BS1 that align with UL subframes of BS2. Thus, BS1 may compare its UL-DL configuration to the UL-DL configuration of BS2 to determine where DL subframes of BS1 align with UL subframes of BS2. For such aligned (or interfering) subframes, BS1 would apply the power down request values (e.g., BS1 would decrease transmit power in accordance with the power down request value(s) for the indicated beam(s) only for such aligned subframes).

At 420, BS1 may reschedule transmission of any muted beams to a non-interfering subframe (e.g., where there is a DL subframe of BS1 aligned with a DL subframe of BS2). DL subframes from both BSs would not create the same kind of interference as the DL-to-UL interference that is being mitigated using the power down request values. Thus, aligned DL subframes for BS1 and BS2 may be considered as non-interfering subframes (DL-to-UL interference does not occur for such subframes). For example, DL subframe 322A of BS1 and DL subframe 322B of BS2 may be considered as non-interfering subframes. Therefore, a muted beam (muted by BS1 in response to a power down request value from BS2) may be rescheduled by BS1 for transmission during DL subframe 322A, e.g., without causing DL-to-UL interference with BS2.

At 422, BS1 may transmit signals or data via one or more of the (offending/interfering) beams (for which a power down request value was received) by using a decreased transmit power in accordance with the received power down request value for such beam(s). Also, at 422, according to an example implementation, for any muted beam that was rescheduled to a non-interfering DL subframe of BS1, BS1 may transmit the signals/data in the rescheduled subframe via such beam at full power (without using a decreased transmit power).

According to an example implementation, one or more features may be provided, including:

1) Using BCH (broadcast control channel) transmissions (e.g., beam reference signals) for determining beam-specific power-down request values for interference mitigation on the BS-to-BS interference links (e.g., to mitigate DL-to-UL interference between BSs).

2) Exchanging (between BSs) UL-DL configurations (TDD configurations) and power down request values for one or more beams

3) Applying the power down request values only in the interfering subframes or slots (e.g., where DL-to-UL interference is possible) based on the neighbor BS's UL-DL configuration.

4) Power down request values may also entirely preclude transmissions (mute request) on certain high-interference beams, e.g., where a very high power down request value is provided, or a mute request is provided as the power down request value.

5) Transmissions that need to occur with a high-interference beam can be re-scheduled in non-interfering subframe or time slot (i.e., subframes that are downlink subframes for both neighboring BSs). And,

6) Using beam-specific power down request values as a form of BS-to-BS CSI (channel state information) feedback and using these requests to form spatial nulls in the beam directions corresponding to the highest power down requests (e.g., to use these power down request values to mute beams corresponding to the highest power down request values).

One or more implementations are provided for a distributed BS-to-BS interference mitigation scheme, based on a limited exchange of information over the backhaul between BSs. According to an example implementation, each BS may scan BCH (the broadcast control channel) transmissions of the neighbor BSs and measures RSRPs (e.g., RSRP of beam reference signals received via BCH) corresponding to the dominant interfering beams from the neighbor BSs. These RSRP measurements may be converted into power-down request values for the neighbor BSs. Furthermore, the specific UL-DL configurations (or TDD patterns) may be exchanged between neighbor BSs.

An illustrative example implementation may employ four beams (actual systems may utilize a significantly higher number of beams). Suppose BS1 has received the following power down request values from its neighbors BS2 and BS3 as shown in Table 2. Given the power down requests for its DL beams from the neighbor BSs and their respective dynamic UL-DL configurations, each BS selects an appropriate beam and power level for its DL transmission. In Table 2, ‘x’ denotes a “don't care”, so full power can be used on Beam-1. For Beam-2, BS1 decreases transmit power by 10 dB based on power down request from BS2. For Beam-3, BS1 decreases transmit power by 15 dB based on the −15 dB power down request from BS2 being greater than the −5 dB power down request value from BS3. Thus, BS1 may receive a power down request value from multiple other BSs, and may select a transmit power that accommodates or satisfies all power down request values for a beam. Beam-4 is not to be used during DL subframes/slots at BS1 that will interfere with the UL slots of BS2, and a power back-off (or power down request) value of −15 dB is to be used if Beam-4 is selected. Note that the requested power down request values can be also used for scheduling decisions at BS1. For instance, DL MSs requesting Beam-4 at BS1 are not going to be scheduled during the UL slots of BS2.

TABLE 2
Example of per-beam (or beam-specific)
power-down request values.

| | | Power-down |
|---|---|---|
| Beam | Power-down request | request from |
| index | from BS2 | BS3 |
| 1 | x | x |
| 2 | −10 dB | x |
| 3 | −15 dB | −5 dB |
| 4 | −Inf dB (e.g., beam | −5 dB |
| | mute request) | |

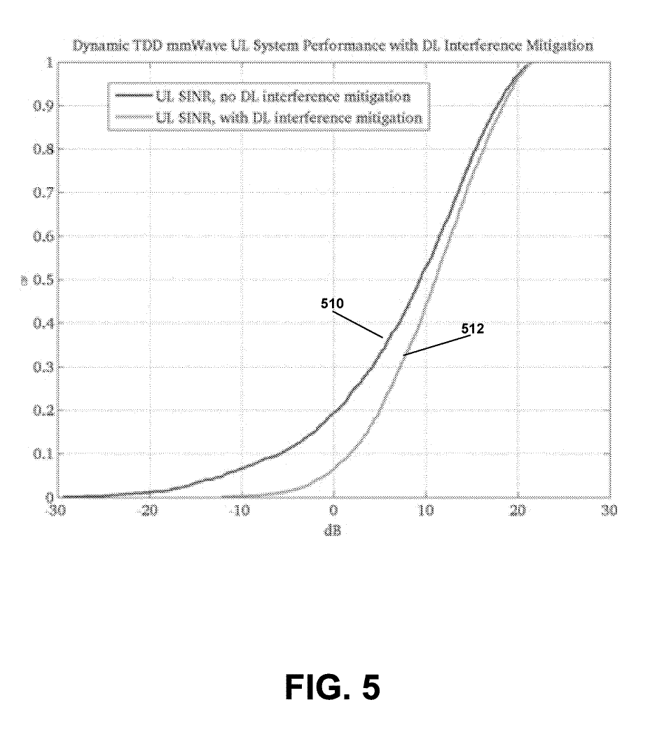

FIG. 5 is a diagram illustrating SINR gain of a system that uses DL interference mitigation, as compared to a system that did not use DL interference mitigation, according to an illustrative example. In FIG. 5, Simulation results indicate significant SINR improvement with this scheme, as shown in FIG. 5. The vertical axis shows cumulative distribution function, and the horizontal axis shows SINR gain. The line 510 indicates UL SINR where no DL interference mitigation is used, and the line 512 indicates UL SINR where DL interference mitigation has been used. As shown in FIG. 5, for a CDF (cumulative distribution function) of around 0.5 (vertical axis), it can be seen that a SINR gain of almost 10 dB can be achieved by using the interference mitigation techniques according to an example implementation.

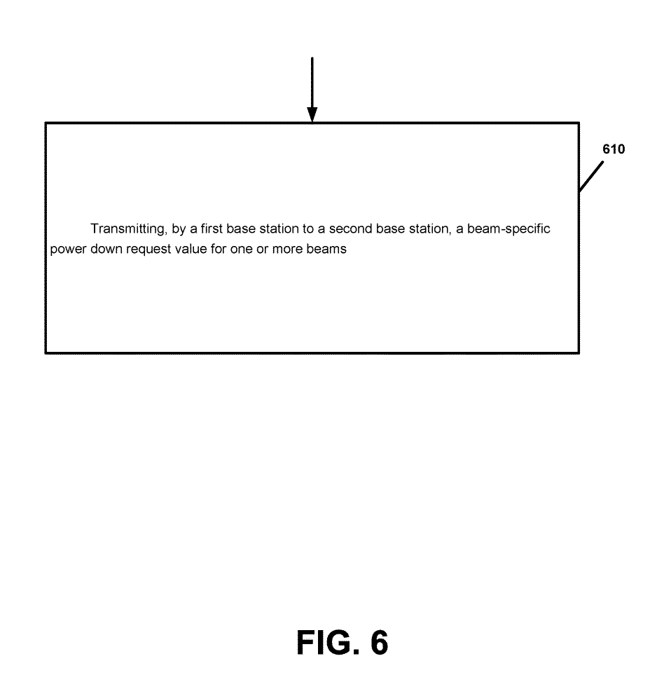

FIG. 6 is a flow chart illustrating operation of a base station according to an example implementation. Operation 610 includes transmitting, by a first base station to a second base station, a beam-specific power down request value for one or more beams.

According to an example implementation of the method of FIG. 6, the method may further include transmitting, by the first base station to the second base station, an uplink-downlink configuration for the first base station.

According to an example implementation of the method of FIG. 6, the method may further include receiving, by the first base station from the second base station, a beam reference signal for each of a plurality of beams; measuring, by the first base station, a signal parameter for the beam reference signal for each of the plurality of beams; and determining, by the first base station based on the measuring, the beam-specific power down request value for one or more of the plurality of beams; and wherein the transmitting comprises transmitting, by the first base station to the second base station, the beam-specific power down request value for one or more of the plurality of beams.

According to an example implementation of the method of FIG. 6, wherein the beam-specific power down request value for one or more beams is applicable only for downlink subframes of the second base station that align with uplink subframes of the first base station.

According to an example implementation of the method of FIG. 6, wherein the beam-specific power down request value for one or more beams includes at least one of: a beam-specific power down request value that requests the second base station to decrease transmit power for a specified beam by a specified amount; and a beam-specific power down request value that requests the second base station to mute a specified beam.

According to an example implementation of the method of FIG. 6, the method may further include wherein the beam-specific power down request value for one or more beams includes at least one of: a beam-specific power down request value that requests the second base station to decrease transmit power for a specified beam by a specified amount only for downlink subframes of the second base station that align with uplink subframes of the first base station; and a beam-specific power down request value that requests the second base station to mute a specified beam only for downlink subframes of the second base station that align with uplink subframes of the first base station.

According to an example implementation of the method of FIG. 6, wherein the measuring includes: measuring, by the first base station, a reference signal received power for the beam reference signal for each of the plurality of beams.

According to an example implementation of the method of FIG. 6, wherein the determining includes: comparing, by the first base station, the signal parameter for the beam reference signal for one or more of the plurality of beams to one or more thresholds; and determining, by the first base station based on the comparing, the beam-specific power down request value for one or more of the plurality of beams.

An apparatus includes at least one processor and at least one memory including computer instructions, when executed by the at least one processor, cause the apparatus to: transmit, by a first base station to a second base station, a beam-specific power down request value for one or more beams.

According to an example implementation of the apparatus, and further causing the apparatus to transmit, by the first base station to the second base station, an uplink-downlink configuration for the first base station.

According to an example implementation of the apparatus, and further causing the apparatus to receive, by the first base station from the second base station, a beam reference signal for each of a plurality of beams; measure, by the first base station, a signal parameter for the beam reference signal for each of the plurality of beams; and determine, by the first base station based on the measuring, the beam-specific power down request value for one or more of the plurality of beams; and wherein the causing the apparatus to transmit comprises causing the apparatus to transmit, by the first base station to the second base station, the beam-specific power down request value for one or more of the plurality of beams.

According to an example implementation of the apparatus, wherein the beam-specific power down request value for one or more beams is applicable only for downlink subframes of the second base station that align with uplink subframes of the first base station.

According to another example implementation, a computer program product may include a computer-readable storage medium and storing executable code that, when executed by at least one data processing apparatus, is configured to cause the at least one data processing apparatus to perform a method including: transmitting, by a first base station to a second base station, a beam-specific power down request value for one or more beams.

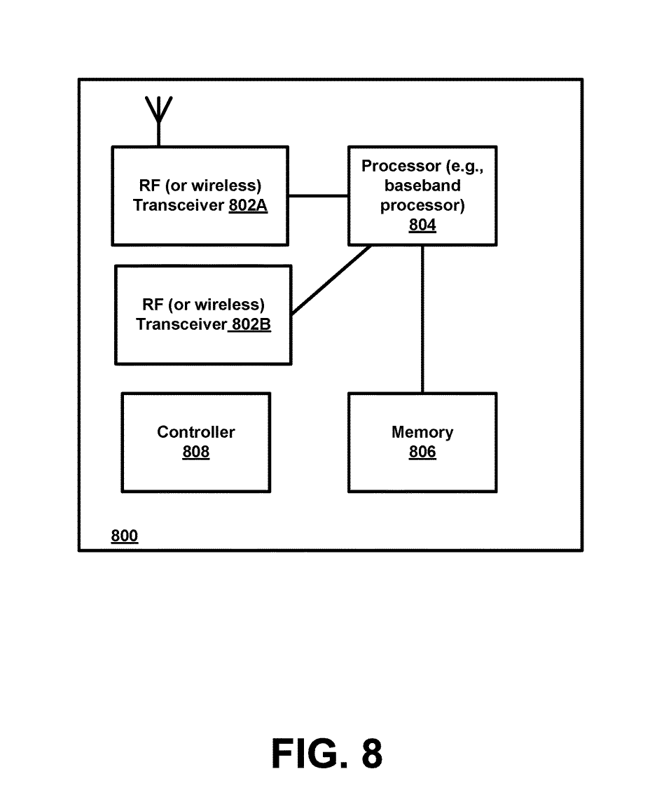

According to another example implementation, an apparatus may include means (e.g., 802A/802B, and/or 804, FIG. 8) for transmitting, by a first base station to a second base station, a beam-specific power down request value for one or more beams, and means (e.g., 802A/802B, and/or 804, FIG. 8) for transmitting, by the first base station to the second base station, an uplink-downlink configuration for the first base station.

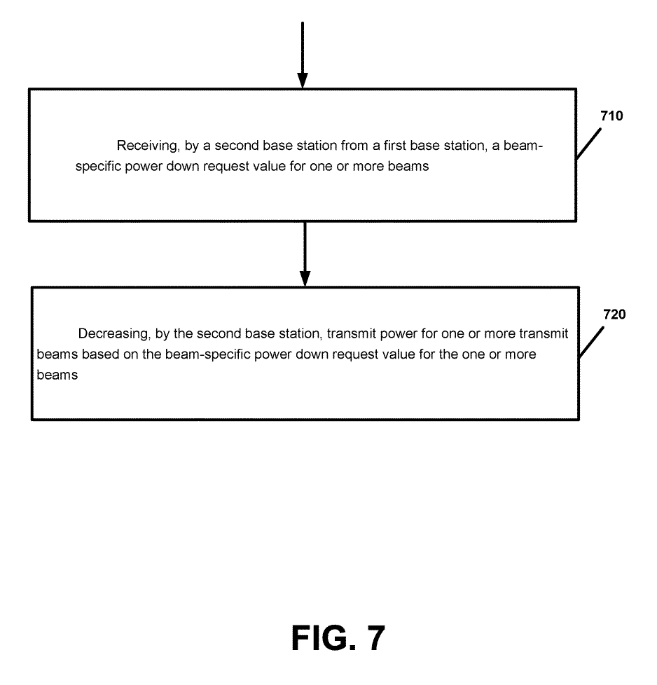

FIG. 7 is a flow chart illustrating operation of a base station according to another example implementation. Operation 710 includes receiving, by a second base station from a first base station, a beam-specific power down request value for one or more beams. And, operation 720 includes decreasing, by the second base station, transmit power for one or more transmit beams based on the beam-specific power down request value for the one or more beams.

According to an example implementation of the method of FIG. 7, the method may further include receiving, by the second base station from the first base station, an uplink-downlink configuration for the first base station; and wherein the decreasing comprises decreasing transmit power for one or more beams based on the beam-specific power down request value for the one or more beams only for downlink subframes of the second base station that align with uplink subframes of the first base station.

According to an example implementation of the method of FIG. 7, wherein the beam-specific power down request value for one or more beams is applicable only for downlink subframes of the second base station that align with uplink subframes of the first base station.

According to an example implementation of the method of FIG. 7, wherein the decreasing transmit power for one or more beams may include: decreasing, by the second base station, transmit power for one or more beams comprises muting one or more beams based on the beam-specific power down request value for the one or more beams for downlink subframes of the second base station that align with uplink subframes of the first base station; and the method further including: rescheduling, by the second base station, the transmission of one or more muted beams to a downlink subframe of the second base station that aligns with a downlink subframe of the first base station.

According to an example implementation of the method of FIG. 7, the method may further include rescheduling, by the second base station, the transmission of one or more beams that were decreased to a downlink subframe of the second base station that aligns with a downlink subframe of the first subframe.

According to an example implementation of the method of FIG. 7, wherein the beam-specific power down request value for one or more beams includes at least one of: a beam-specific power down request value that requests the second base station to decrease transmit power for a specified beam by a specified amount; and a beam-specific power down request value that requests the second base station to mute a specified beam.

According to an example implementation of the method of FIG. 7, wherein the beam-specific power down request value for one or more beams includes at least one of: a beam-specific power down request value that requests the second base station to decrease transmit power for a specified beam by a specified amount only for downlink subframes of the second base station that align with uplink subframes of the first base station; and a beam-specific power down request value that requests the second base station to mute a specified beam only for downlink subframes of the second base station that align with uplink subframes of the first base station.

According to an example implementation of the method of FIG. 7, the method may further include receiving, by the second base station from the first base station, a beam-specific don't care indication that indicates that the second base station may use a full transmission power for one or more beams.

According to an example implementation, an apparatus includes at least one processor and at least one memory including computer instructions, when executed by the at least one processor, cause the apparatus to: receive, by a second base station from a first base station, a beam-specific power down request value for one or more beams; and decrease, by the second base station, transmit power for one or more transmit beams based on the beam-specific power down request value for the one or more beams.

According to an example implementation of the apparatus, and further causing the apparatus to receive, by the second base station from the first base station, an uplink-downlink configuration for the first base station; and wherein causing the apparatus to decrease comprises causing the apparatus to decrease transmit power for one or more beams based on the beam-specific power down request value for the one or more beams only for downlink subframes of the second base station that align with uplink subframes of the first base station.

According to an example implementation of the apparatus wherein the beam-specific power down request value for one or more beams is applicable only for downlink subframes of the second base station that align with uplink subframes of the first base station.

According to an example implementation of the apparatus, and further causing the apparatus to reschedule, by the second base station, the transmission of one or more beams that were decreased to a downlink subframe of the second base station that aligns with a downlink subframe of the first base station.

According to an example implementation of the apparatus, and further causing the apparatus to transmit, by the second base station, beam reference signals for a plurality of beams.

According to an example implementation, a computer program product includes a computer-readable storage medium and storing executable code that, when executed by at least one data processing apparatus, is configured to cause the at least one data processing apparatus to perform a method including: receiving, by a second base station from a first base station, a beam-specific power down request value for one or more beams; and decreasing, by the second base station, transmit power for one or more transmit beams based on the beam-specific power down request value for the one or more beams.

According to an example implementation, an apparatus may include means (e.g., 802A/802B, and/or 804, FIG. 8) for receiving, by a second base station from a first base station, a beam-specific power down request value for one or more beams; and means (e.g., 802A/802B, and/or 804, FIG. 8) for decreasing, by the second base station, transmit power for one or more transmit beams based on the beam-specific power down request value for the one or more beams.

FIG. 8 is a block diagram of a wireless station (e.g., BS or user device) 800 according to an example implementation. The wireless station 800 may include, for example, two RF (radio frequency) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
transmitting, by a first base station to a second base station, a beam-specific power down request value for one or more beams.

2. The method of claim 1 and further comprising:
transmitting, by the first base station to the second base station, an uplink-downlink configuration for the first base station.

3. The method of claim 1 and further comprising:
receiving, by the first base station from the second base station, a beam reference signal for each of a plurality of beams;
measuring, by the first base station, a signal parameter for the beam reference signal for each of the plurality of beams; and
determining, by the first base station based on the measuring, the beam-specific power down request value for one or more of the plurality of beams; and
wherein the transmitting comprises transmitting, by the first base station to the second base station, the beam-specific power down request value for one or more of the plurality of beams.

4. The method of claim 1 wherein the beam-specific power down request value for one or more beams is applicable only for downlink subframes of the second base station that align with uplink subframes of the first base station.

5. The method of claim 1 wherein the beam-specific power down request value for one or more beams comprises at least one of:
a beam-specific power down request value that requests the second base station to decrease transmit power for a specified beam by a specified amount; and
a beam-specific power down request value that requests the second base station to mute a specified beam.

6. The method of claim 1 wherein the beam-specific power down request value for one or more beams comprises at least one of:
a beam-specific power down request value that requests the second base station to decrease transmit power for a specified beam by a specified amount only for downlink subframes of the second base station that align with uplink subframes of the first base station; and
a beam-specific power down request value that requests the second base station to mute a specified beam only for downlink subframes of the second base station that align with uplink subframes of the first base station.

7. The method of claim 3 wherein the measuring comprises:
measuring, by the first base station, a reference signal received power for the beam reference signal for each of the plurality of beams.

8. The method of claim 3 wherein the determining comprises:
comparing, by the first base station, the signal parameter for the beam reference signal for one or more of the plurality of beams to one or more thresholds;
determining, by the first base station based on the comparing, the beam-specific power down request value for one or more of the plurality of beams.

9. An apparatus comprising at least one processor and at least one memory including computer instructions, when executed by the at least one processor, cause the apparatus to:
transmit, by a first base station to a second base station, a beam-specific power down request value for one or more beams.

10. The apparatus of claim 9 and further causing the apparatus to:
transmit, by the first base station to the second base station, an uplink-downlink configuration for the first base station.

11. The apparatus of claim 9 and further causing the apparatus to:
receive, by the first base station from the second base station, a beam reference signal for each of a plurality of beams;
measure, by the first base station, a signal parameter for the beam reference signal for each of the plurality of beams; and
determine, by the first base station based on the measuring, the beam-specific power down request value for one or more of the plurality of beams; and
wherein the causing the apparatus to transmit comprises causing the apparatus to transmit, by the first base station to the second base station, the beam-specific power down request value for one or more of the plurality of beams.

12. The apparatus of claim 9 wherein the beam-specific power down request value for one or more beams is applicable only for downlink subframes of the second base station that align with uplink subframes of the first base station.

13. A method comprising:
receiving, by a second base station from a first base station, a beam-specific power down request value for one or more beams; and
decreasing, by the second base station, transmit power for one or more transmit beams based on the beam-specific power down request value for the one or more beams.

14. The method of claim 13 and further comprising:
receiving, by the second base station from the first base station, an uplink-downlink configuration for the first base station; and
wherein the decreasing comprises decreasing transmit power for one or more beams based on the beam-specific power down request value for the one or more beams only for downlink subframes of the second base station that align with uplink subframes of the first base station.

15. The method of claim 13 wherein the beam-specific power down request value for one or more beams is applicable only for downlink subframes of the second base station that align with uplink subframes of the first base station.

16. The method of claim 13 wherein the decreasing transmit power for one or more beams comprises:
decreasing, by the second base station, transmit power for one or more beams comprises muting one or more beams based on the beam-specific power down request value for the one or more beams for downlink subframes of the second base station that align with uplink subframes of the first base station; and
the method further comprising:
rescheduling, by the second base station, the transmission of one or more muted beams to a downlink subframe of the second base station that aligns with a downlink subframe of the first base station.

17. The method of claim 13 and further comprising:
rescheduling, by the second base station, the transmission of one or more beams that were decreased to a downlink subframe of the second base station that aligns with a downlink subframe of the first subframe.

18. The method of claim 13 wherein the beam-specific power down request value for one or more beams comprises at least one of:
a beam-specific power down request value that requests the second base station to decrease transmit power for a specified beam by a specified amount; and
a beam-specific power down request value that requests the second base station to mute a specified beam.

19. The method of claim 13 wherein the beam-specific power down request value for one or more beams comprises at least one of:
a beam-specific power down request value that requests the second base station to decrease transmit power for a specified beam by a specified amount only for downlink subframes of the second base station that align with uplink subframes of the first base station; and
a beam-specific power down request value that requests the second base station to mute a specified beam only for downlink subframes of the second base station that align with uplink subframes of the first base station.

20. The method of claim 13 and further comprising:
receiving, by the second base station from the first base station, a beam-specific don't care indication that indicates that the second base station may use a full transmission power for one or more beams.

21. An apparatus comprising at least one processor and at least one memory including computer instructions, when executed by the at least one processor, cause the apparatus to:
receive, by a second base station from a first base station, a beam-specific power down request value for one or more beams; and
decrease, by the second base station, transmit power for one or more transmit beams based on the beam-specific power down request value for the one or more beams.

22. The apparatus of claim 21 and further causing the apparatus to:
receive, by the second base station from the first base station, an uplink-downlink configuration for the first base station; and
wherein causing the apparatus to decrease comprises causing the apparatus to decrease transmit power for one or more beams based on the beam-specific power down request value for the one or more beams only for downlink subframes of the second base station that align with uplink subframes of the first base station.

23. The apparatus of claim 21 wherein the beam-specific power down request value for one or more beams is applicable only for downlink subframes of the second base station that align with uplink subframes of the first base station.

24. The apparatus of claim 21 and further causing the apparatus to:
reschedule, by the second base station, the transmission of one or more beams that were decreased to a downlink subframe of the second base station that aligns with a downlink subframe of the first base station.

25. The apparatus of claim 21 and further causing the apparatus to:
transmit, by the second base station, beam reference signals for a plurality of beams.
